(19) United States
(12) Patent Application Publication
(10) Pub. No.: US 2007/0202913 A1
(43) Pub. Date: Aug. 30, 2007

(54) BASE STATION AND RADIO COMMUNICATION METHOD

(75) Inventor: Koichiro BAN, Kawasaki-Shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 11/677,784

(22) Filed: Feb. 22, 2007

(30) Foreign Application Priority Data
Feb. 27, 2006 (JP) 2006-050626

(51) Int. Cl. H04Q 7/20

(52) U.S. Cl. 455/522; 370/318; 455/69

(57) ABSTRACT

There is provided with a base station which carries out radio communication with mobile stations, including: a frame generation section configured to successively generate time frames to be transmitted to the mobile stations; a storage configured to store transmit power information specifying transmission power to be applied for each of a predetermined number of time frames being successive as one of first transmit power covering a whole of the communication area, second to nth (n is an integer equal to or greater than 2) transmit power covering areas smaller than the whole of the communication area; a transmit power control section configured to control transmit power of time frames successively generated by the frame generation section according to the transmit power information in units of the predetermined number of time frames; and a transmission section configured to transmit time frames power-controlled by the transmit power control section.

### CROSS-REFERENCE TO RELATED APPLICATIONS

This application is based upon and claims the benefit of priority from the prior Japanese Patent Applications No. 2006-50626 filed on Feb. 27, 2006, the entire contents of which are incorporated herein by reference.

### BACKGROUND OF THE INVENTION

1. Field of the Invention

The present invention relates to a base station in a cellular communication system and a radio communication method performed by the base station, and more particularly, to transmit power control over time frames transmitted sequentially from the base station.

2. Related Art

According to time division multiplexing in a conventional cellular communication system, a base station divides 1 frame into a plurality of time slots and transmits data to a plurality of user terminals (mobile stations) in a cell by using different time slots. When neighboring base stations transmit data to user terminals in their respective cells using an identical frequency and same time slot, if some user terminal is located in the neighborhood of a cell boundary, there is a problem that interference from the neighboring base stations increases considerably.

Examples of conventional methods for solving such a problem include a method whereby only one base station transmits data simultaneously or a method whereby transmit power control is performed according to a situation in which slots in neighboring cells are used.

In this way, according to a scheme of allocating user terminals to time slots at a conventional base station, only one base station at a time can transmit data in an identical time slot at an identical frequency. Or information such as a situation in which each time slot is used, transmit power, received signal strength of user terminals must be shared among different base stations and each base station cannot perform channel allocation independently. For these reasons, it is an issue how all base stations reuse an identical frequency to construct a cellular communication system with high frequency utilization efficiency.

### SUMMARY OF THE INVENTION

According to an aspect of the present invention, there is provided with a base station which carries out radio communication with mobile stations, a communication area of which partially overlaps with a communication area of one or more other base station, comprising:

a frame generation section configured to successively generate time frames to be transmitted to the mobile stations;

a storage configured to store transmit power information specifying transmission power to be applied for each of a predetermined number of time frames being successive as one of first transmit power covering a whole of the communication area, second to nth (n is an integer equal to or greater than 2) transmit power covering areas smaller than the whole of the communication area;

a transmit power control section configured to control transmit power of time frames successively generated by the frame generation section according to the transmit power information in units of the predetermined number of time frames; and

a transmission section configured to transmit time frames power-controlled by the transmit power control section.

According to an aspect of the present invention, there is provided with a radio communication method performed by a base station which carries out radio communication with mobile stations, a communication area of which partially overlaps with a communication area of one or more other base station, comprising:

successively generating time frames to be transmitted to the mobile stations;

controlling transmit power of successively generated time frames in units of a predetermined number of time frames based on transmit power information specifying transmit power to be applied for each of the predetermined number of time frames as one of first transmit power covering the whole communication area, second to nth (n is an integer equal to or greater than 2) transmit power covering areas smaller than the whole communication area; and

transmitting time frames power-controlled.

According to an aspect of the present invention, there is provided with a base station which carries out radio communication with mobile stations, a communication area of which partially overlaps with a communication area of one or more other base station, comprising:

a frame generation section configured to successively generate time frames to be transmitted to the mobile stations;

a storage configured to store transmit power information specifying transmission power to be applied for each of a predetermined number of time frames being successive as one of first transmit power covering a whole of the communication area, second to nth (n is an integer equal to or greater than 2) transmit power covering areas smaller than the whole of the communication area, wherein the transmit power information is repeatedly used in units of the predetermined number of time frames;

a transmit power control section configured to control transmit power of time frames successively generated by the frame generation section according to the transmit power information; and

a transmission section configured to transmit time frames power-controlled by the transmit power control section.

### BRIEF DESCRIPTION OF THE DRAWINGS

FIG. 1 shows an example of cells formed by base stations according to an embodiment of the present invention;

FIGS. 2A and 2B illustrate a method of controlling transmit power of time frames;

FIG. 3 shows an example of cells formed by base stations provided with a sector antenna;

FIG. 4 shows an example of controlling transmit power with three types of electric power;

FIG. 5 shows an example of a time frame;

FIG. 6 shows an example of transmit power control of time frames whose size is variable;

FIG. 7 shows an example of transmit power control of overlapping time frames with large electric power;

FIG. 8 shows an example of frequency division;

FIG. 9 shows an example of frequency division by data type;

FIG. 10 shows an example of frequency division through exclusive allocation;

FIG. 11 shows an example of pilot signals;

FIG. 12 shows an example of pilot signals with constant electric power;

FIG. 13 shows an example of a user terminal;

FIG. 14 shows an example of a base station;

FIG. 15 is a flow chart showing an example of time frame allocation processing;

FIG. 16 is a flow chart showing another example of time frame allocation processing; and

FIG. 17 is a flow chart showing an example of processing of selecting a modulation/coding scheme.

### DETAILED DESCRIPTION OF THE INVENTION

Hereinafter, this embodiment will be explained in detail with reference to the attached drawings.

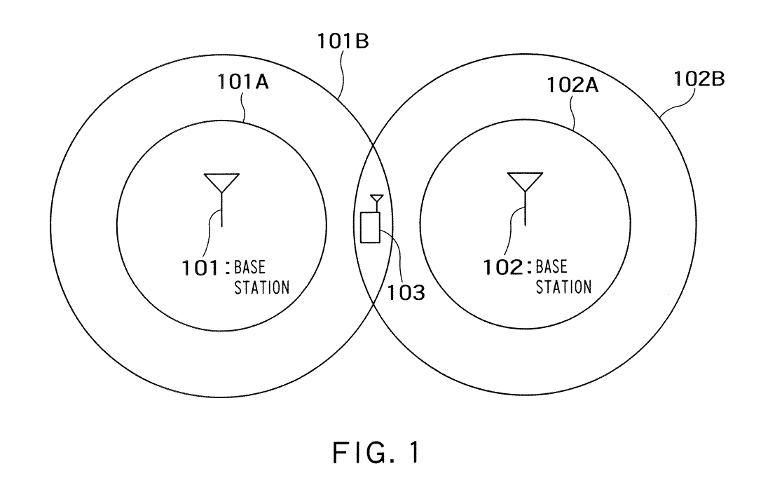

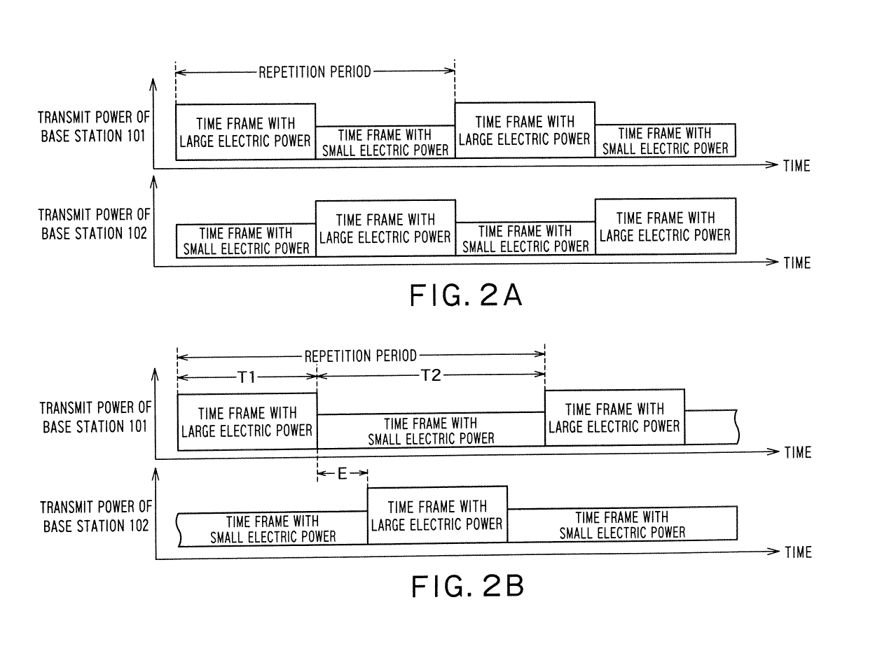

FIG. 1 shows an embodiment of a cellular communication system according to the present invention. FIG. 2A and FIG. 2B illustrate time frame transmit power control carried out by the base stations in FIG. 1.

In FIG. 1, a base station 101 and a base station 102 have the function of transmitting time frames with large electric power which covers a whole cell and time frames with small electric power which covers only the neighborhood of the base stations.

Reference numeral 101A denotes a cover range (communication area) when the base station 101 transmits time frames with small electric power and 101B denotes a cover range when the base station 101 transmits time frames with large electric power. In the same way, reference numeral 102A denotes a cover range when the base station 102 transmits time frames with small electric power and 102B denotes a cover range when the base station 102 transmits time frames with large electric power. Reference numeral 103 denotes a user terminal (mobile station) located in an area where the cover range 101B and cover range 102B overlap each other.

As shown in FIG. 2A, the base station 101 and base station 102 periodically transmit time frames with large electric power which covers the whole cell and time frames with small electric power which covers only the neighborhood of each base station. In this example, the length of each time frame is identical and also the period is 2 frames long. In this case, the base station 101 and base station 102 each transmit time frames with large electric power at timing different from that of the other neighboring base station. In this way, interference between the neighboring cells can be restrained by carrying out periodic transmit power control such that the base station 101 and base station 102 do not transmit time frames with large electric power at the same time.

Here, as shown in FIG. 2B, the length (T1) of a time frame with large electric power may be different from the length (T2) of a time frame with small electric power. In this case, transmission timings of the base station 101 and the base station 102 need not be exactly synchronized with each other. That is, it is possible to prevent both base stations from simultaneously transmitting time frames with large electric power by controlling a difference (E) in the transmission timing between the base station 101 and the base station 102 to between 0 and T2-T1. Therefore, even when the length (T1) of the time frame with large electric power is different from the length (T2) of the time frame with small electric power, interference between the cells can be restrained.

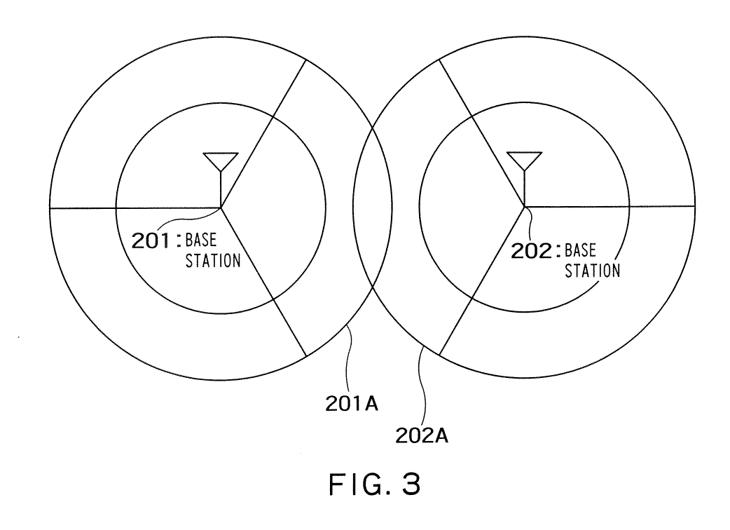

FIG. 3 shows an example of the configuration when the base station is provided with a 3-sector antenna.

It is also possible to perform the transmit power control shown in FIG. 2A and FIG. 2B over sectors 201A and 202A which are situated in the direction in which the base station 201 and base station 202 face each other.

The example where time frames with two types of electric power are used has been explained so far, but the base station may periodically and repeatedly transmit time frames with three or more types of electric power. In this way, it is possible to perform more detailed control over interference among neighboring cells.

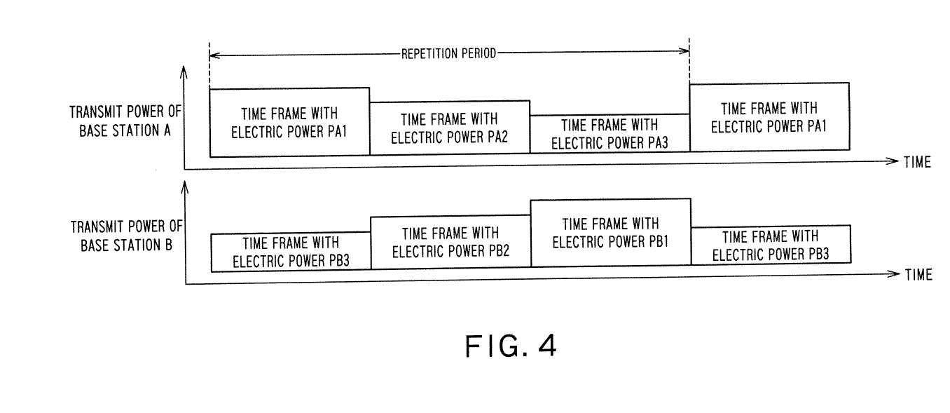

FIG. 4 shows an example of transmit power control at neighboring base station A and base station B when using time frames with three types of electric power.

In FIG. 4, the base station A periodically transmits time frames with three types of electric power of PA1, PA2, PA3 (PA1>PA2>PA3) and the base station B periodically transmits time frames with three types of electric power of PB3, PB2, PB1 (PB1>PB2>PB3). In this example, the period is 3 frames long. Electric power PA1 covers the whole cell of the base station A and electric power PB1 covers the whole cell of the base station B. Because a time frame with electric power PA1 and a time frame with electric power PB1 are never transmitted at the same time, interference among the cells is restrained.

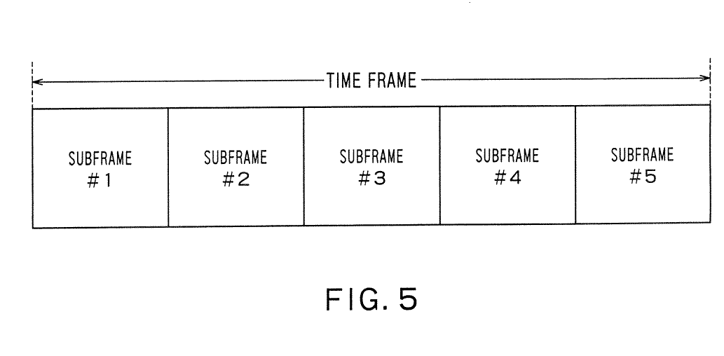

FIG. 5 shows an example of the format of a time frame.

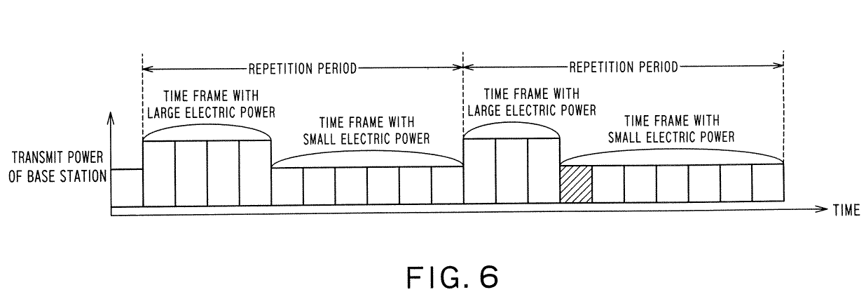

One time frame is divided into a plurality of subframes and the base station allocates data to be transmitted to a user terminal to any one of subframes in a time frame of a specific type (large electric power or small electric power). Furthermore, as shown in FIG. 6, the number of subframes contained in one time frame may differ from one type of time frame to another. Or, it is also possible to make the number of subframes included in one time frame variable so as to make the time frame configuration more flexible. For example, as shown in the hatching of FIG. 6, it is also possible to decrement the number of subframes of the time frame with large electric power by 1 by reducing electric power of the last subframe of the time frame with large electric power and increment the number of subframes of the time frame with small electric power next to the time frame with large electric power by 1 instead.

Among data transmitted from the base station, there are also data which should be transmitted to all or a plurality of user terminals in the cell like broadcast data or multicast data or the like. In such a case, it is efficient to use subframes in a time frame with maximum electric power so that broadcast data or multicast data are transmitted to the whole cell.

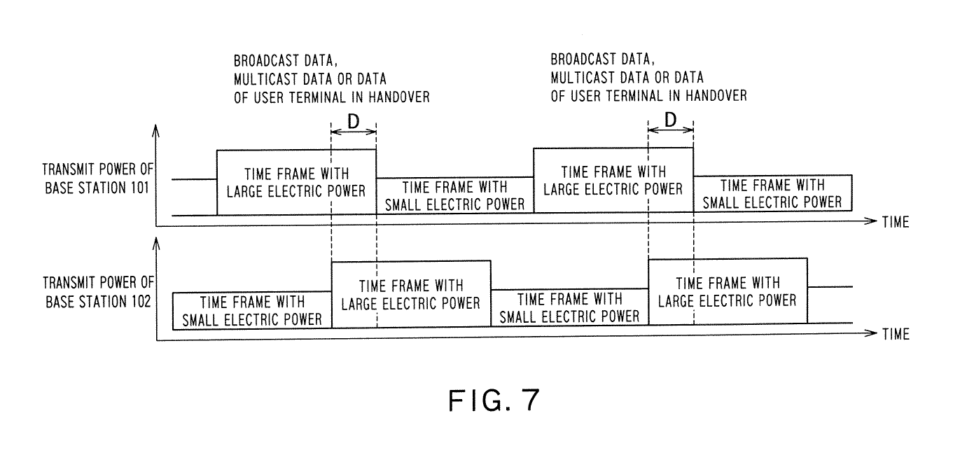

Here, according to the method of controlling transmit power shown in FIG. 2A and FIG. 2B, control is performed such that time frame with the large electric power transmitted from the neighboring base station does not overlap temporally, but as shown in FIG. 7, the base station can also perform transmit power control such that a time frame with large electric power transmitted by the own station and a time frame with large electric power transmitted from a neighboring base station partially overlap each other. It is also possible to allocate (map) broadcast data or multicast data to a section (subframe) D during which time frames with large electric power are being transmitted at the same time from the two neighboring base stations. Compared with a case where broadcast data or multicast data is transmitted individually for each cell, performing such transmission control makes it possible to transmit broadcast data or multicast data to the whole cell efficiently in a shorter time. Furthermore, during the section (subframe) D during which time frames with large electric power are being transmitted at the same time from the two neighboring base stations, it is also possible to simultaneously transmit from the two base stations data to a user terminal in handover which is moving between the two base stations. Performing such transmission control makes it possible for the user terminal to simultaneously receive the same data from the two base stations and realize stable handover when the user terminal moves.

For example, in the case of an OFDM system, when the same data (broadcast data, multicast data or data to a user terminal in handover) are transmitted simultaneously from two neighboring base stations, if the difference in the reception timing of the corresponding data at the user terminal is the length of a cyclic prefix or below, the data can be received without any inter-symbol interference.

The above described example has shown the case where the base station performs transmit power control over all the usable frequency band every time frame, but the base station can also perform the above described transmit power control using only some of all frequency band (some of subcarriers) and always transmit time frames with maximum electric power for the remaining frequency band (subcarriers) without performing any transmit power control. Moreover, it is also possible to divide frequency band (subcarriers) not to be subjected to transmit power control among the neighboring base stations and exclusively allocate each divided frequency band (subband) to the respective base stations for use.

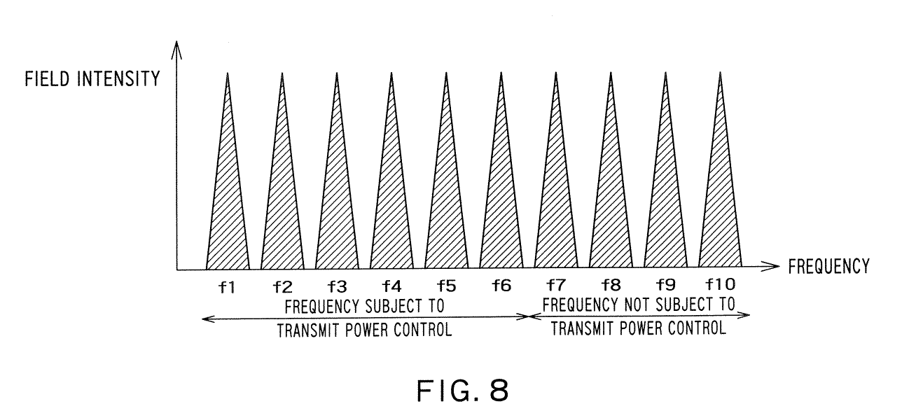

FIG. 8 shows an example of the method whereby all frequency band (all subcarriers) are divided into frequency subbands (subcarriers) to be subjected to transmit power control and subbands (subcarriers) not to be subjected to transmit power control.

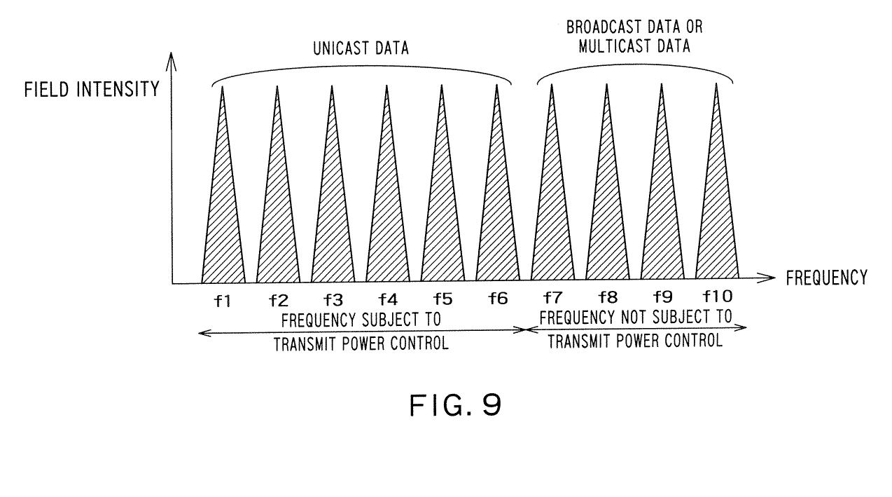

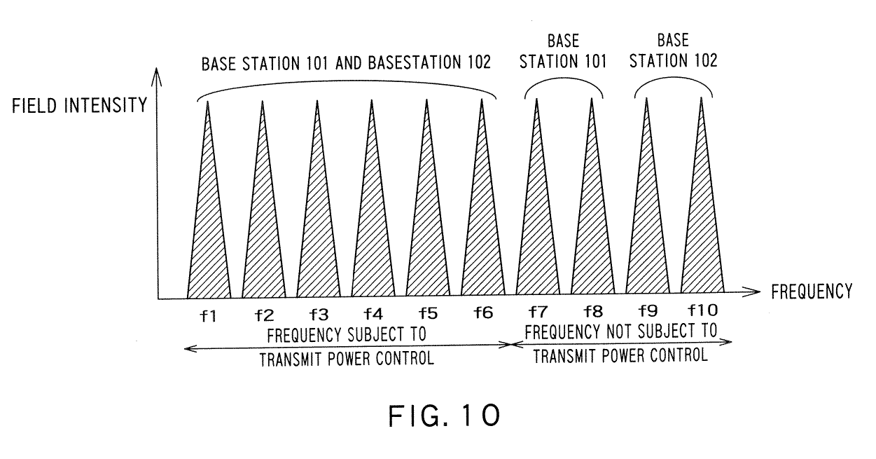

Frequency subbands f1 to of f6 are subjected to transmit power control and frequency subbands from f7 to f10 are not subjected to transmit power control. For the frequency subbands f7 to f10, only time frames with maximum electric power which covers the whole cell are transmitted. For example, as shown in FIG. 9, unicast data is transmitted using the frequency subbands f1 to f6, while broadcast or multicast data is transmitted using the frequency subbands f7 to f10. Or, as shown in FIG. 10, it is also possible to share the frequency subbands f1 to f6 between the neighboring base station A and base station B, and exclusively allocate f7 and f8 to the base station A and exclusively allocate f9 and f10 to the base station B.

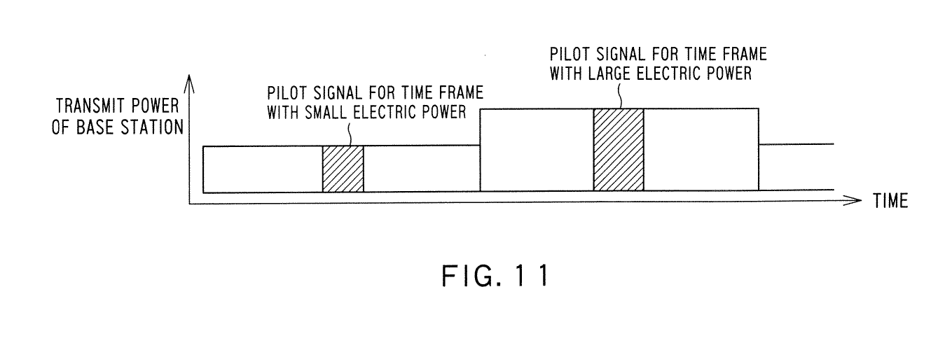

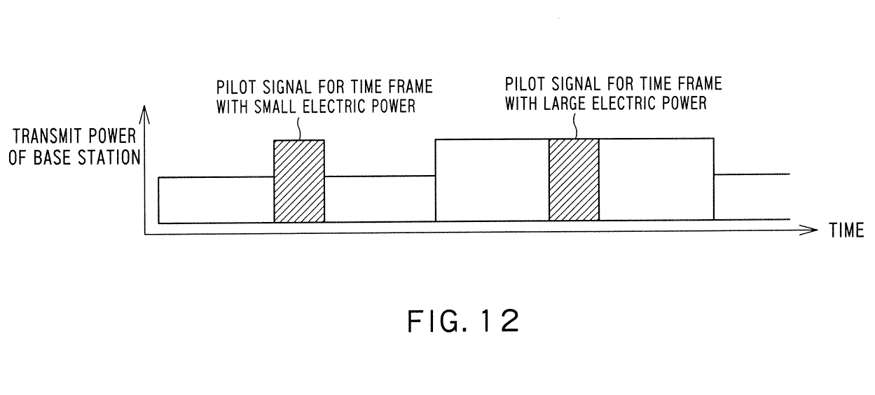

Here, the base station has the function of selecting time frames to be used for data transmission to the user terminals according to received signal quality and positions of the user terminals in the cell. Furthermore, when a user terminal moves in the cell, the base station has the function of changing allocation of time frames to be used for data transmission to the user terminal. To realize these functions, the base station generates M (M is an integers equal to or greater than 2) types of pilot signals or known signals corresponding to time frames with M types of electric power respectively and transmits the respective pilot signals or known signals as parts of the corresponding time frames. As shown in FIG. 11, transmit power of M types of pilot signals may be the same as the electric power of the corresponding time frames, or as shown in FIG. 12, it may always be constant irrespective of the type of a time frame. The user terminal measures received signal strength of pilot signals or known signals, and generates feedback information based on the measurement result and transmits it to the base station. The base station determines the type of the time frame to be applied to the corresponding user terminal based on the feedback information received from the user terminal. The method of determining the type of the time frame to be applied to the user terminal will be described later.

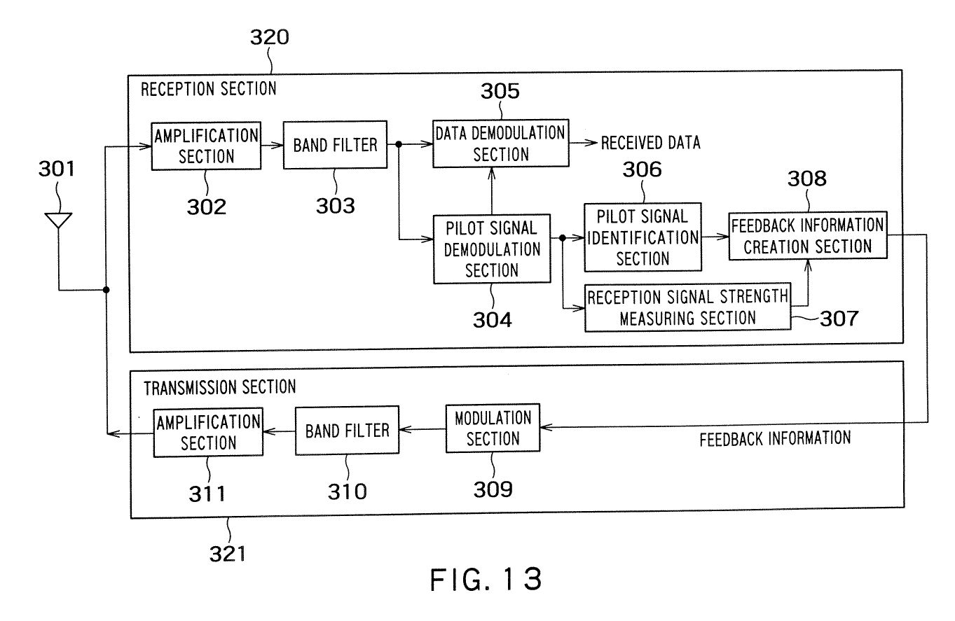

FIG. 13 is a block diagram showing an example of the configuration of a user terminal.

The user terminal is provided with an antenna 301, a reception section 320 and a transmission section 321.

The reception section 320 includes an amplification section 302, a band filter 303, a pilot signal demodulation section 304, a data demodulation section 305, a pilot signal identification section 306, a received signal strength measuring section 307 and a feedback information creation section 308. The transmission section 321 includes a modulation section 309, a band filter 310 and an amplification section 311.

A radio signal received at the antenna 301 from the base station is amplified at the amplification section 302, then only a signal in a specific band is extracted by the band filter 303, a pilot subcarrier signal of the extracted signal is inputted to the pilot signal demodulation section 304 and a data subcarrier signal is inputted to the data demodulation section 305. The pilot signal demodulation section 304 estimates a communication channel (channel response) using the pilot signal and demodulates the pilot signal based on the result of the channel response estimation. The pilot signal demodulation section 304 outputs the signal showing the result of the channel response estimation to the data demodulation section 305 and outputs the demodulated pilot data to the pilot signal identification section 306 and also outputs the pilot signal to the received signal strength measuring section 307.

The data demodulation section 305 demodulates the data signal based on the result of the above described channel response estimation, and outputs the demodulated data (received data) to an application (not shown).

The pilot signal identification section 306 identifies the type of the pilot signal based on the pilot data inputted from the pilot signal demodulation section 304 and outputs the signal showing the type of the identified pilot signal to the feedback information creation section 308.

The received signal strength measuring section 307 measures the received signal strength of the pilot signal inputted from the pilot signal demodulation section 304 and outputs the information indicating the measured received signal strength to the feedback information creation section 308.

The feedback information creation section 308 generates feedback information to the base station from the information indicating the type of the pilot signal inputted from the pilot signal identification section 306 and the information indicating the received signal strength of the pilot signal inputted from the received signal strength measuring section 307.

For example, the feedback information may be information indicating the received signal strength of the pilot signal itself. Or it is also possible to calculate the quantity of propagation attenuation in the communication path from the type of the pilot signal and the received signal strength and generate information on the calculated amount of propagation attenuation as the feedback information. Or it is also possible to compare the received signal strength of the pilot signal with a threshold corresponding to the type of the pilot signal and generate information on the comparison result as the feedback information. Besides, it is also possible to generate information indicating the type of time frames requested by the user terminal as the feedback information.

The modulation section 309 at the transmission section 321 modulates the feedback information created by the feedback information creation section 308 and generates a modulated signal. The band filter 310 extracts only a signal in a band to be used in the communication path from the generated modulated signal and outputs it. The amplification section 311 amplifies the signal outputted from the band filter 310 and transmits it to the base station from the antenna 301.

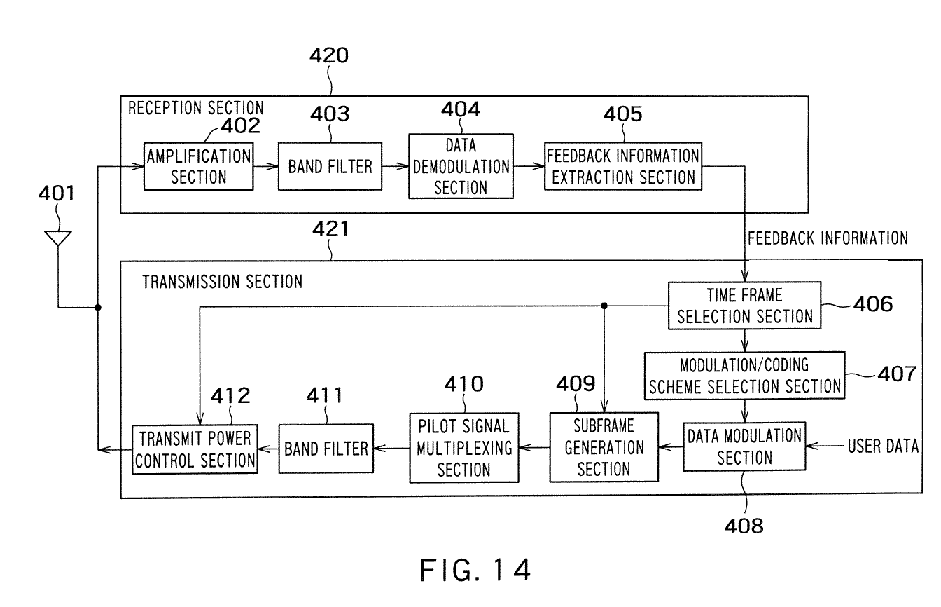

FIG. 14 is a block diagram showing an example of the configuration of the base station.

The base station is provided with an antenna 401, a reception section 420 and a transmission section 421.

The reception section 420 includes an amplification section 402, a band filter 403, a data demodulation section 404 and a feedback information extraction section 405. The transmission section 421 includes a time frame selection section 406, a modulation/coding scheme selection section 407, a data modulation section 408, a subframe generation section 409, a pilot signal multiplexing section (mapping section) 410, a band filter 411 and a transmit power control section 412.

A radio signal received at the antenna 401 from the user terminal is amplified at the amplification section 402, then only a signal in a specific band is extracted by the band filter 403 and the extracted signal is inputted to the data demodulation section 404 as the received signal. The data demodulation section 404 demodulates the inputted received signal and outputs reception data. The feedback information extraction section 405 extracts feedback information from the reception data and outputs it to the time frame selection section 406 at the transmission section 421.

The time frame selection section 406 selects the type of time frames to be used for data transmission to the user terminal by using the feedback information inputted from the feedback information extraction section 405. For example, when the received signal strength of the pilot signal for time frames with small electric power is included in the feedback information, the time frame selection section 406 compares this received signal strength with a threshold for small electric power and when the received signal strength is equal to or higher than the threshold, it allocates the data to be transmitted to this user terminal to time frames with small electric power, and when the received signal strength is lower than the threshold, it determines to allocate the data to time frames with large electric power. In the case of a TDD (Time Division Duplex) scheme which uses the same frequency band for transmission and reception, it is possible to select time frames by comparing a received signal strength of the signal from the user terminal with the threshold. The time frame selection section 406 notifies the information indicating the selected type of the time frames about the user terminal to the modulation/coding scheme selection section 407.

Furthermore, the time frame selection section 406 manages the transmit power information defining which of small electric power or large electric power (first to nth transmit power) should be used as the transmit power for each of a predetermined number of contiguous time frames. The time frame selection section 406 notifies this transmit power information to the subframe generation section 409 and the transmit power control section 412. The details of the processing carried out by the time frame selection section 406 will be described later.

The modulation/coding scheme selection section 407 selects a combination of the modulation and the coding schemes which corresponds to the type of the time frames selected by the time frame selection section 406 and outputs the information indicating the combination of the selected modulation and coding schemes together with the information indicating the type of the time frames inputted from time frame selection section 406 to the data modulation section 408. In this way, the data modulation section 408 grasps the modulation and coding schemes and the type of the time frames for each user terminal.

The data modulation section 408 performs modulation and coding on user data or control data or both data to be transmitted to the user terminal in the time frames according to the modulation and coding schemes selected by the modulation/coding scheme selection section 407 in time frame units and outputs the modulated and coded data to the subframe generation section (frame generation section) 409. The control data may contain, for example, information indicating the type of time frames to be applied to the user terminal, the modulation and coding schemes to be applied to the user terminal. Furthermore, the control data may be broadcast data or multicast data.

The subframe generation section 409 generates time frames from the type of time frames to be transmitted and the data inputted from data modulation section 408. In this case, the subframe generation section 409 may generate time frames according to the timing information which indicates generation timing of the time frames. In this case, a timer (not shown) or GPS in the own station may be used. This timing information is the one that specifies generation timing such that the transmission time of time frames having the largest transmit power by the own station and the transmission time of time frames having the largest transmit power by the neighboring base station do not overlap each other. Or this timing information is the one that specifies generation timing such that the transmission time of the time frames having the largest transmit power by the own station and the transmission time of the time frames having the largest transmit power by the neighboring base station partially overlap each other. In the latter case, the subframe generation section 409 may allocate broadcast or multicast data to the parts which overlap the time frames having the largest transmit power by the neighboring base station in the time frames whose transmit power is controlled to the largest transmit power.

Furthermore, the subframe generation section 409 may also decrease or increase the number of subframes of a certain time frame (for example, time frame with maximum electric power) and increase or decrease the number of subframes of a time frame next to this certain time frame by the amount decreased or increased.

Furthermore, the subframe generation section 409 may also allocate broadcast data or multicast data to the time frames transmitted with the largest transmit power.

The pilot signal multiplexing section 410 generates pilot signal corresponding to the type of the time frame generated by the subframe generation section 409 and map (multiplexes) the generated pilot signal to this time frame.

The data of the time frames outputted from the pilot signal multiplexing section 410 are modulated under a predetermined modulation scheme and then inputted to the transmit power control section 412 through the band filter 411.

The transmit power control section 412 transmits the signal of the time frames inputted from the band filter 411 by controlling its transmit power corresponding to the type of these time frames, from the antenna 401 to the user terminal as a radio signal.

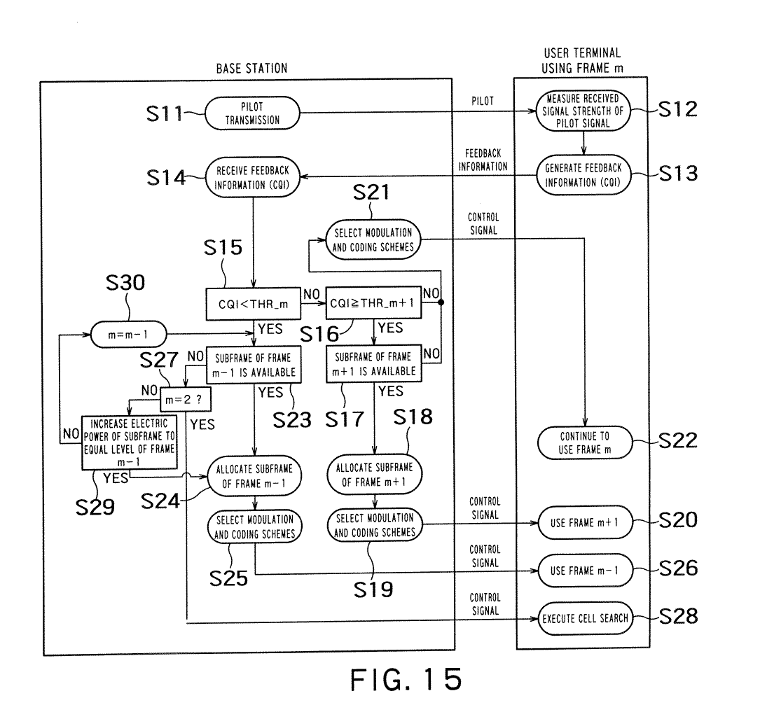

FIG. 15 is a flow chart illustrating details of the processing carried out by the time frame selection section 406.

Suppose that the base station allocates subframes in an mth (m is a natural number not exceeding M) time frame of M (M is an integer equal to or greater than 2) types of time frames to the user terminal. Suppose that the smaller the time frame number, the greater the transmit power becomes. Furthermore, suppose that the base station receives a value (called “CQI” (Channel Quality Indicator) here) which is inversely proportional to the propagation attenuation as the feedback information from the user terminal.

The base station transmits time frames including pilot signals to the user terminal (S11). The user terminal measures the received signal strength of the pilot signal (S12) and generates feedback information (S13). The user terminal transmits the generated feedback information to the base station and the base station receives this feedback information (CQI) (S14).

When CQI reaches and exceeds THR_m (NO of S15) as the user terminal moves in the direction toward the cell center or the like and when CQI further reaches and exceeds THR_m+1 (YES of S16), the base station determines to allocate an (m+1)th time frame for the data transmission to this user terminal if some subframes of the (m+1)th time frame are free (YES of S17) (S18). The modulation/coding scheme selection section 407 selects the modulation and coding schemes which correspond to the (m+1)th time frame (S19) and the base station includes the information indicating the selected modulation and coding schemes and the information indicating that the (m+1)th time frame has been allocated to the user terminal in the control signal (control data) and transmits the signal to the user terminal (S20).

When the (m+1)th time frame has no free space (NO of S17) or CQI is equal to or above THR_m and smaller than THR_m+1 (NO of S16), the base station determines to allow the user terminal to continue to use the mth time frame (S21, S22). In this case, the base station may also include the information indicating that the base station allows the user terminal to continue to use the current modulation and coding schemes and the mth time frame in the control signal and transmit the signal to the user terminal (S22).

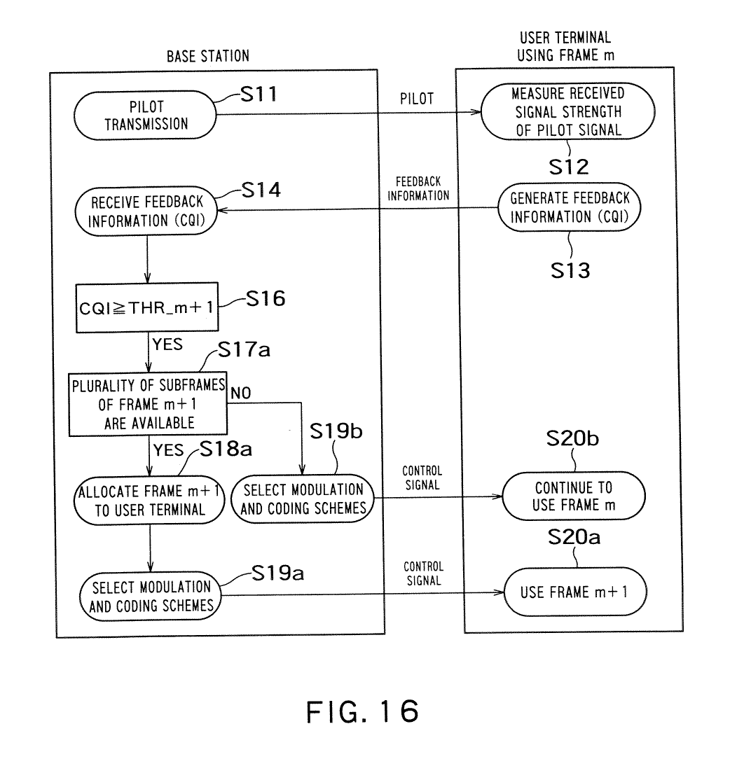

Here, to prevent decrease in the data rate caused by the change of the modulation and coding schemes when changing the electric power of the time frame to smaller power, it is also possible to judge whether or not a plurality of subframes can be allocated to the user terminal as shown in FIG. 16 instead of S17 (S17a). When possible (YES of S17a), the base station determines to allocate a plurality of subframes of the (m+1)th time frame to the user terminal (S18a to S20a). On the other hand, when not possible, the base station determines to allow the user terminal to continue to use the current modulation and coding schemes and the mth time frame (19b, 20b).

Returning to FIG. 15, when CQI falls below THR_m as the user terminal moves in the direction toward the cell boundary or the like (YES of S15), the base station judges whether or not some subframes of the (m−1)th time frame are free (S23). If there are free subframes (YES of S23), the base station determines to allocate the (m−1)th time frame for the data transmission to this user terminal (S24 to S26). When there are no free subframes (NO of S23), if m is 2 (YES of S27), the base station may transmit a control signal including instruction information instructing a cell search to the user terminal. In this case, the user terminal executes a cell search and if it is possible to receive a signal from a neighboring base station, the user terminal sends a request for connection to the neighboring base station and performs handover to the neighboring base station (S28). If m is not 2 (NO of S27), it is possible to increase the subframe of the mth time frame to the electric power of the (m−1)th time frame (YES of S29) and allocate it to the user terminal (S24). Or if the time frame whose electric power is greater than m−1 has a free subframe (NO of S29, S30), it is also possible to allocate the user terminal to the time frame (S23, S24).

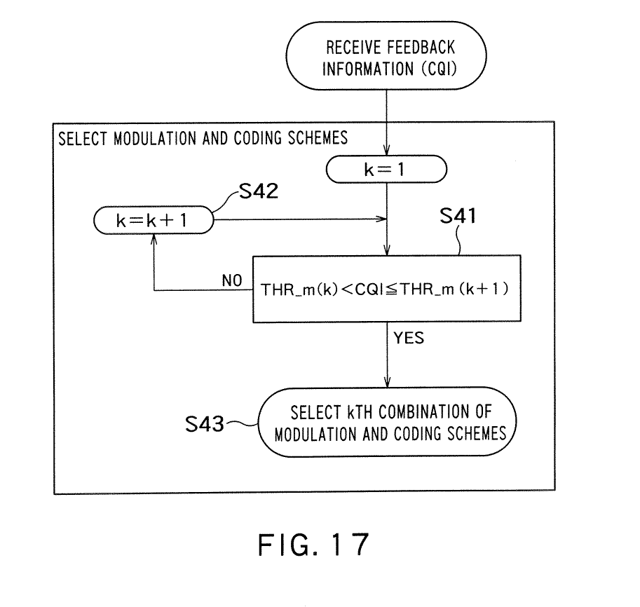

FIG. 17 is a flow chart illustrating the processing (S19, 521, 525) of selecting the modulation and coding schemes carried out at the modulation/coding scheme selection section 407.

For example, suppose it is possible to select one of X (X is an integer equal to or greater than 1) combinations of modulation and coding schemes. When the value of k (k is a natural number equal to or below X) is incremented by 1 at a time (NO of S41, S42) and CQI falls within a certain range (THR_m(k)<=CQI<THR_m(k+1)) (YES of S41), the kth combination of modulation and coding schemes are selected (543).

As described above, according to the this embodiment, the base station periodically performs transmit power control over time frames, changes the cell range covered by the base station, and it is thereby possible to reduce interference with user terminals located in the vicinity of the cell boundary without communication quality information on the user terminals of the base stations being shared among the base stations and thereby realize a cellular communication system with high efficiency of frequency utilization.

What is claimed is:

1. A base station which carries out radio communication with mobile stations, a communication area of which partially overlaps with a communication area of one or more other base station, comprising:
a frame generation section configured to successively generate time frames to be transmitted to the mobile stations;
a storage configured to store transmit power information specifying transmission power to be applied for each of a predetermined number of time frames being successive as one of first transmit power covering a whole of the communication area, second to nth (n is an integer equal to or greater than 2) transmit power covering areas smaller than the whole of the communication area;
a transmit power control section configured to control transmit power of time frames successively generated by the frame generation section according to the transmit power information in units of the predetermined number of time frames; and
a transmission section configured to transmit time frames power-controlled by the transmit power control section.

2. The base station according to claim 1,
wherein the transmission section has a sector antenna which forms a plurality of sectors in the communication area,
the storage section stores the transmit power information on respective sectors,
the frame generation section successively generates the time frames of each sector to be transmitted to the mobile stations,
the transmit power control section controls transmit power of the time frames of each sector generated by the frame generation section, and
the transmission section transmits the time frames of each sector power-controlled by the transmit power control section.

3. The base station according to claim 1, wherein the frame generation section generates the time frames according to timing information which specifies timing of generating time frames such that time frames having the first transmit power transmitted by the transmission section and time frames having the first transmit power transmitted by the other base station do not overlap each other.

4. The base station according to claim 1,
wherein the time frame has a plurality of subframes,
the frame generation section decreases or increases subframes of a certain time frame and increases or decreases subframes of another time frame neighboring the certain time frame by a number of subframes decreased or increased from the certain time frame.

5. The base station according to claim 4, wherein the certain time frame is time frame to be power-controlled to the first transmit power.

6. The base station according to claim 1, wherein the frame generation section allocates broadcast data or multicast data to time frames power-controlled to the first transmit power.

7. The base station according to claim 1, wherein the frame generation section generates the time frames according to timing information which specifies timing of generating time frames such that time frames having the first transmit power transmitted by the transmission section and time frames having the first transmit power transmitted by the other base station partially overlap each other and maps broadcast or multicast data to parts which overlap each other in the time frames having the first transmit power transmitted by the transmission section and the other base station.

8. The base station according to claim 1, wherein the transmit power control section controls transmit power on some subcarriers in each time frame according to the transmit power information and controls transmit power of remaining subcarriers in each time frame to the first transmit power.

9. The base station according to claim 1, further comprising:
a mapping section configured to map n types of known signals associated with the first to nth transmit power to time frames to be power-controlled to the first to nth transmit power;
a reception section configured to receive information for identifying the type of the known signal and information indicating reception level of the known signal as feedback information from the mobile station; and
a selection section configured to select time frame to be used for data transmission to the mobile station from among the predetermined number of time frames based on the feedback information and the transmit power information.

10. The base station according to claim 1, further comprising:
a mapping section configured to map n types of known signals associated with the first to nth transmit power to time frames to be power-controlled to the first to nth transmit power; and
a reception section configured to receive feedback information indicating which of the first to nth transmit power should be applied for data transmission to the mobile station, from the mobile station.

11. A radio communication method performed by a base station which carries out radio communication with mobile stations, a communication area of which partially overlaps with a communication area of one or more other base station, comprising:
successively generating time frames to be transmitted to the mobile stations;
controlling transmit power of successively generated time frames in units of a predetermined number of time frames based on transmit power information specifying transmit power to be applied for each of the predetermined number of time frames as one of first transmit power covering the whole communication area, second to nth (n is an integer equal to or greater than 2) transmit power covering areas smaller than the whole communication area; and
transmitting time frames power-controlled.

12. A base station which carries out radio communication with mobile stations, a communication area of which partially overlaps with a communication area of one or more other base station, comprising:
a frame generation section configured to successively generate time frames to be transmitted to the mobile stations;
a storage configured to store transmit power information specifying transmission power to be applied for each of a predetermined number of time frames being successive as one of first transmit power covering a whole of the communication area, second to nth (n is an integer equal to or greater than 2) transmit power covering areas smaller than the whole of the communication area, wherein the transmit power information is repeatedly used in units of the predetermined number of time frames;
a transmit power control section configured to control transmit power of time frames successively generated by the frame generation section according to the transmit power information; and
a transmission section configured to transmit time frames power-controlled by the transmit power control section.
